(19) United States
(12) Patent Application Publication
(10) Pub. No.: US 2003/0169279 A1
(43) Pub. Date: Sep. 11, 2003

(54) Reconfigurable pixel computation unit

(76) Inventors: Ranjit S. Oberoi, Saratoga, CA (US); Anthony S. Ramirez, Sunnyvale, CA (US); Brian D. Emberling, San Mateo, CA (US)

Correspondence Address: Jeffrey C. Hood, Conley, Rose, & Tayon, P.C., P.O. Box 398, Austin, TX, 78767, US

(21) Appl. No.: 10/091,384

(22) Filed: Mar. 5, 2002

(51) Int. Cl. G09G 5/00; G06F 13/00

(52) U.S. Cl. 345/643; 345/536

(57) ABSTRACT

A reconfigurable system for performing a set of arithmetic operations. The reconfigurable system may have a frame buffer, an accumulation buffer and a pixel computation unit. The pixel computation unit includes a control unit and one or more copies of a reconfigurable circuit. The reconfigurable circuit may include a subtractor, a multiplier, an adder, and a set of multiplexors. The control logic drives selects lines of the set of multiplexors in the one or more circuit copies through one or more computational cycles in order to implement a programmable operation (such as scale and/or bias, accumulate, dynamic blend and matrix multiply). The pixel computation unit may receive pixels values from one or more sources including the frame buffer and the texture buffer, and operate on the pixels using the one or more circuit copies to generate a stream of output pixels.

### BACKGROUND OF THE INVENTION

1. Field of the Invention

This invention relates generally to the field of computer graphics and, more particularly, to a reconfigurable system for performing a set of pixel computation operations.

2. Description of the Related Art

A graphics accelerator may provide hardware resources which are accessible by host software (i.e. by software running on a host computer coupled to the graphics accelerator). It would be desirable for the graphics accelerator to provide hardware support for a wide variety of fundamental operations. However, the naive strategy of “a separate circuit for each operation/function” would require a large amount of chip area or board space. Because these commodities are in such high demand, there exists a need for circuits, devices and systems which are capable of performing multiple different functions with a limited set of circuit elements. It would be desirable if the multiple different functions included functions such as the Open GL Accumulate function, scale and bias functions, color space conversions as these functions are widely used among graphics programmers.

### SUMMARY OF THE INVENTION

In one set of embodiments, a reconfigurable system for performing a set of arithmetic operations may be configured as follows. The reconfigurable system may include a frame buffer, a texture buffer and a pixel computation unit (e.g. a pixel transfer unit). The frame buffer may include an image buffer. The texture buffer may include an accumulation buffer. The pixel computation unit may include a control unit and one or more copies of a reconfigurable circuit.

The reconfigurable circuit may include a subtractor, a multiplier, an adder, and a set of multiplexors. The control logic drives selects lines of the set of multiplexors in the one or more circuit copies through one or more computational cycles in order to implement a programmable operation. The pixel computation unit may receive pixels values (or more generally, data values) from one or more sources including the frame buffer and the texture buffer, and operate on the pixels using the one or more circuit copies to generate a stream of output pixels.

The reconfigurable system may also include one or more circuit elements, devices or subsystems configured to transfer the stream of output pixels to a programmable destination. For example, the programmable destination may be the accumulation buffer or the image buffer.

The programmable operation may include one or more of the following operations: an addition operation, a multiply operation, an accumulate operation, a dynamic blending operation, a matrix-vector multiplication, a load operation and a return operation. The matrix-vector multiplication may be useful for color-space conversions.

One or more of the circuit copies may include an accumulator register for accumulating sums over successive computational cycles. The accumulator register may thus be useful for the matrix-vector multiplications which involves accumulating a sum of products.

In one set of embodiments, the reconfigurable circuit may include a subtractor, a multiplier, an adder, a four multiplexors. The subtractor may be coupled to receive a first input and a second input. The multiplier may be coupled to a third input and an output of the subtractor. The adder may be coupled to a fourth input and an output of the multiplier. The output of the first multiplexor may drive the first input. The output of the second multipexor may drive the second input. The output of the third multiplexor may drive the third input. The output of the fourth multiplexor may drive the fourth input.

In one embodiment, the control logic may be configured to drive the selection lines so that (a) the first multiplexor passes a color value of an image pixel to the first input, (b) the second multiplexor passes a color value of an accumulation buffer pixel to the second input, (c) the third multiplexor passes an alpha component of the image pixel to the third input, (d) the fourth multiplexor passes the color value of the accumulation buffer pixel to the fourth input, in response to a dynamic blending instruction residing in the operation register.

The control logic may be configured to drive the selection lines so that (a) the first multiplexor passes a component of an accumulation buffer pixel to the first input, (b) the second multiplexor passes a zero value to the second input, (c) the third multiplexor passes the value one to the third input, (d) the fourth multiplexor passes a bias value to the fourth input, in response to an add instruction in the operation register.

The control logic is configured to drive the selection lines so that (a) the first multiplexor passes a component of an image pixel to the first input, (b) the second multiplexor passes a zero value to the second input, (c) the third multiplexor passes a scale value to the third input, (d) the fourth multiplexor passes a corresponding component of an accmulation buffer pixel to the fourth input, in response to an accumulate instruction in the operation register.

### BRIEF DESCRIPTION OF THE DRAWINGS

The foregoing, as well as other objects, features, and advantages of this invention may be more completely understood by reference to the following detailed description when read together with the accompanying drawings in which:

FIG. 1 is a perspective view of one embodiment of a computer system;

FIG. 2 is a simplified block diagram of one embodiment of a computer system;

FIG. 3 is a functional block diagram of one embodiment of a graphics system;

FIG. 4 is a functional block diagram of one embodiment of the media processor of FIG. 3;

FIG. 5 is a functional block diagram of one embodiment of the hardware accelerator of FIG. 3;

FIG. 6 is a functional block diagram of one embodiment of the video output processor of FIG. 3;

FIG. 7 is an illustration of a sample space partitioned into an array of bins;

FIG. 8 illustrates one embodiment of a system for blending a sequence of images into an accumulation buffer;

FIG. 9 illustrates one embodiment of a mixing circuit for mixing an image pixel with a corresponding accumulation buffer pixel based on the alpha value of the image pixel;

FIG. 10 illustrates one embodiment of reconfigurable block referred to herein as a scale and bias unit;

FIG. 11 illustrates another embodiment of the scale and bias unit; and

FIG. 12 illustrates a reconfigurable computational unit including control logic and one or more reconfigurable blocks.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. Note, the headings are for organizational purposes only and are not meant to be used to limit or interpret the description or claims. Furthermore, note that the word “may” is used throughout this application in a permissive sense (i.e., having the potential to, being able to), not a mandatory sense (i.e., must).” The term “include”, and derivations thereof, mean “including, but not limited to”. The term “connected” means “directly or indirectly connected”, and the term “coupled” means “directly or indirectly connected”.

### DETAILED DESCRIPTION OF THE PREFERRED EMBODIMENTS

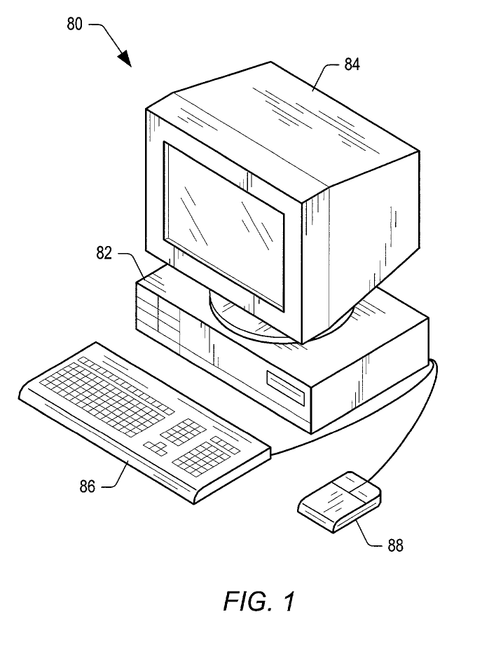

Computer System—FIG. 1

FIG. 1 illustrates one embodiment of a computer system 80 that includes a graphics system. The graphics system may be included in any of various systems such as computer systems, network PCs, Internet appliances, televisions (e.g. HDTV systems and interactive television systems), personal digital assistants (PDAs), virtual reality systems, and other devices which display 2D and/or 3D graphics, among others.

As shown, the computer system 80 includes a system unit 82 and a video monitor or display device 84 coupled to the system unit 82. The display device 84 may be any of various types of display monitors or devices (e.g., a CRT, LCD, or gas-plasma display). Various input devices may be connected to the computer system, including a keyboard 86 and/or a mouse 88, or other input device (e.g., a trackball, digitizer, tablet, six-degree of freedom input device, head tracker, eye tracker, data glove, or body sensors). Application software may be executed by the computer system 80 to display graphical objects on display device 84.

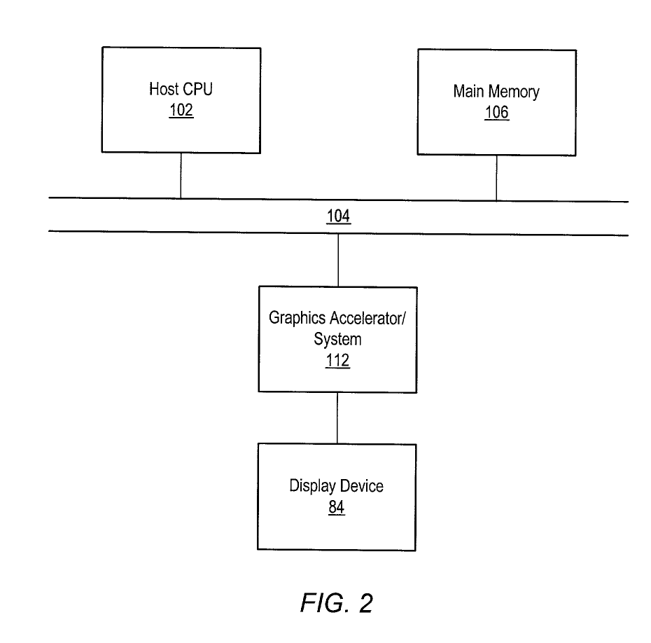

Computer System Block Diagram—FIG. 2

FIG. 2 is a simplified block diagram illustrating the computer system of FIG. 1. As shown, the computer system 80 includes a central processing unit (CPU) 102 coupled to a high-speed memory bus or system bus 104 also referred to as the host bus 104. A system memory 106 (also referred to herein as main memory) may also be coupled to high-speed bus 104.

Host processor 102 may include one or more processors of varying types, e.g., microprocessors, multi-processors and CPUs. The system memory 106 may include any combination of different types of memory subsystems such as random access memories (e.g., static random access memories or “SRAMs,” synchronous dynamic random access memories or “SDRAMs,” and Rambus dynamic random access memories or “RDRAMs,” among others), read-only memories, and mass storage devices. The system bus or host bus 104 may include one or more communication or host computer buses (for communication between host processors, CPUs, and memory subsystems) as well as specialized subsystem buses.

In FIG. 2, a graphics system 112 is coupled to the high-speed memory bus 104. The graphics system 112 may be coupled to the bus 104 by, for example, a crossbar switch or other bus connectivity logic. It is assumed that various other peripheral devices, or other buses, may be connected to the high-speed memory bus 104. It is noted that the graphics system 112 may be coupled to one or more of the buses in computer system 80 and/or may be coupled to various types of buses. In addition, the graphics system 112 may be coupled to a communication port and thereby directly receive graphics data from an external source, e.g., the Internet or a network. As shown in the figure, one or more display devices 84 may be connected to the graphics system 112.

Host CPU 102 may transfer information to and from the graphics system 112 according to a programmed input/output (I/O) protocol over host bus 104. Alternately, graphics system 112 may access system memory 106 according to a direct memory access (DMA) protocol or through intelligent bus mastering.

A graphics application program conforming to an application programming interface (API) such as OpenGL® or Java 3D™ may execute on host CPU 102 and generate commands and graphics data that define geometric primitives such as polygons for output on display device 84. Host processor 102 may transfer the graphics data to system memory 106. Thereafter, the host processor 102 may operate to transfer the graphics data to the graphics system 112 over the host bus 104. In another embodiment, the graphics system 112 may read in geometry data arrays over the host bus 104 using DMA access cycles. In yet another embodiment, the graphics system 112 may be coupled to the system memory 106 through a direct port, such as the Advanced Graphics Port (AGP) promulgated by Intel Corporation.

The graphics system may receive graphics data from any of various sources, including host CPU 102 and/or system memory 106, other memory, or from an external source such as a network (e.g. the Internet), or from a broadcast medium, e.g., television, or from other sources.

Note while graphics system 112 is depicted as part of computer system 80, graphics system 112 may also be configured as a stand-alone device (e.g., with its own built-in display). Graphics system 112 may also be configured as a single chip device or as part of a system-on-a-chip or a multi-chip module. Additionally, in some embodiments, certain of the processing operations performed by elements of the illustrated graphics system 112 may be implemented in software.

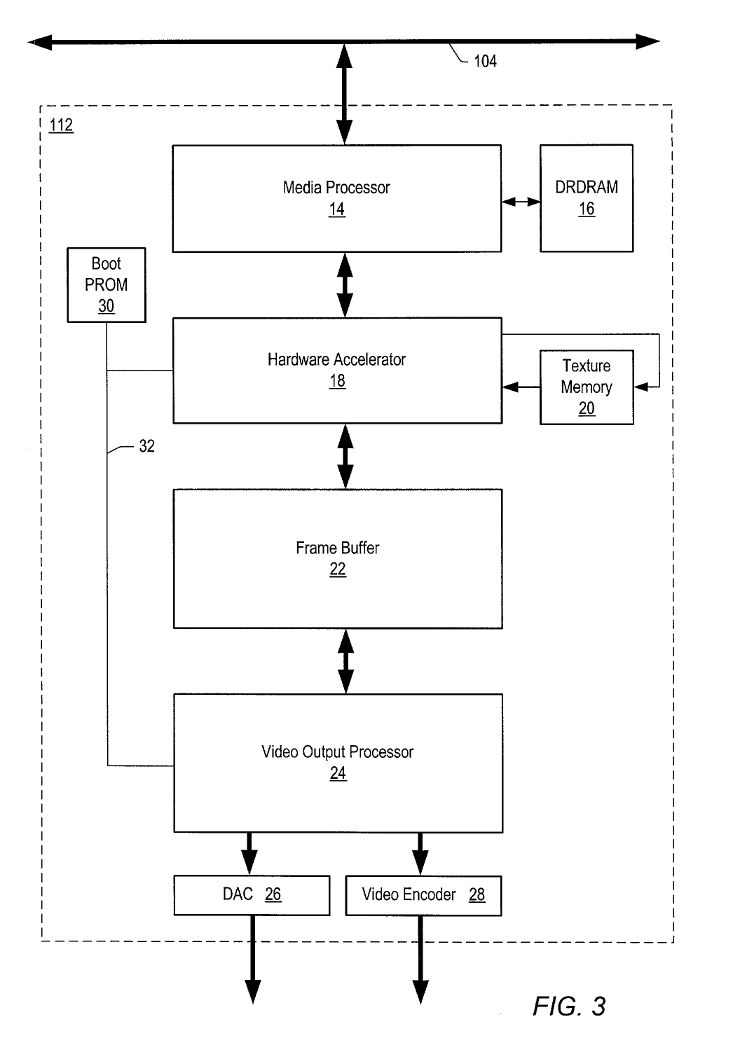

Graphics System—FIG. 3

FIG. 3 is a functional block diagram illustrating one embodiment of graphics system 112. Note that many other embodiments of graphics system 112 are possible and contemplated. Graphics system 112 may include one or more media processors 14, one or more hardware accelerators 18, one or more texture buffers 20, one or more frame buffers 22, and one or more video output processors 24. Graphics system 112 may also include one or more output devices such as digital-to-analog converters (DACs) 26, video encoders 28, flat-panel-display drivers (not shown), and/or video projectors (not shown). Media processor 14 and/or hardware accelerator 18 may include any suitable type of high performance processor (e.g., specialized graphics processors or calculation units, multimedia processors, DSPs, or general purpose processors).

In some embodiments, one or more of these components may be removed. For example, the texture buffer may not be included in an embodiment that does not provide texture mapping. In other embodiments, all or part of the functionality incorporated in either or both of the media processor or the hardware accelerator may be implemented in software.

In one set of embodiments, media processor 14 is one integrated circuit and hardware accelerator is another integrated circuit. In other embodiments, media processor 14 and hardware accelerator 18 may be incorporated within the same integrated circuit. In some embodiments, portions of media processor 14 and/or hardware accelerator 18 may be included in separate integrated circuits.

As shown, graphics system 112 may include an interface to a host bus such as host bus 104 in FIG. 2 to enable graphics system 112 to communicate with a host system such as computer system 80. More particularly, host bus 104 may allow a host processor to send commands to the graphics system 112. In one embodiment, host bus 104 may be a bi-directional bus.

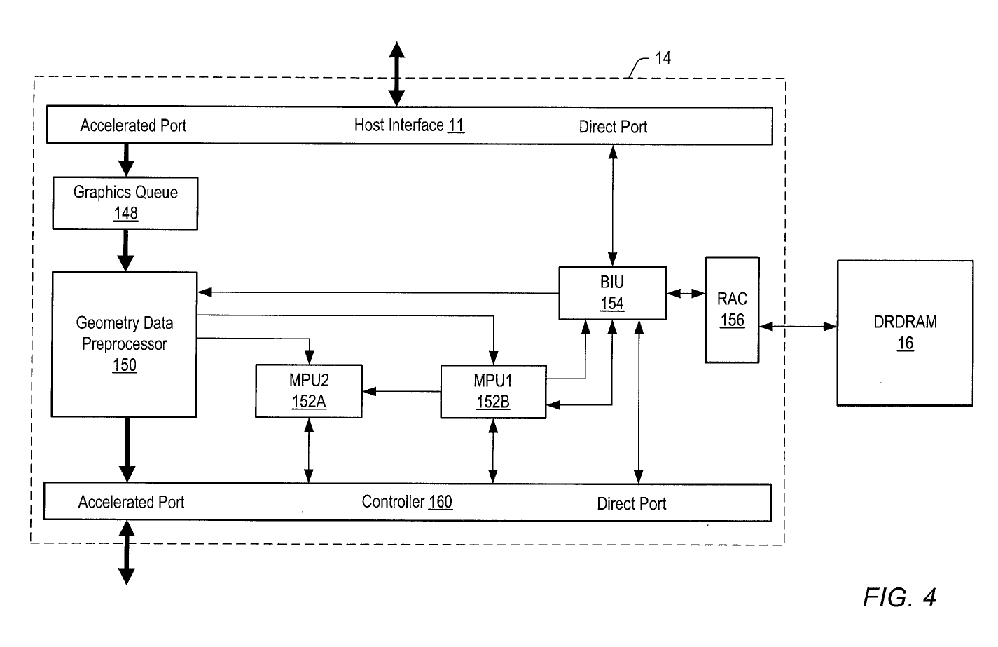

Media Processor—FIG. 4

FIG. 4 shows one embodiment of media processor 14. As shown, media processor 14 may operate as the interface between graphics system 112 and computer system 80 by controlling the transfer of data between computer system 80 and graphics system 112. In some embodiments, media processor 14 may also be configured to perform transformations, lighting, and/or other general-purpose processing operations on graphics data.

Transformation refers to the spatial manipulation of objects (or portions of objects) and includes translation, scaling (e.g. stretching or shrinking), rotation, reflection, or combinations thereof. More generally, transformation may include linear mappings (e.g. matrix multiplications), nonlinear mappings, and combinations thereof.

Lighting refers to calculating the illumination of the objects within the displayed image to determine what color values and/or brightness values each individual object will have. Depending upon the shading algorithm being used (e.g., constant, Gourand, or Phong), lighting may be evaluated at a number of different spatial locations.

As illustrated, media processor 14 may be configured to receive graphics data via host interface 11. A graphics queue 148 may be included in media processor 14 to buffer a stream of data received via the accelerated port of host interface 11. The received graphics data may include one or more graphics primitives. As used herein, the term graphics primitive may include polygons, parametric surfaces, splines, NURBS (nonuniform rational B-splines), sub-divisions surfaces, fractals, volume primitives, voxels (i.e., three-dimensional pixels), and particle systems. In one embodiment, media processor 14 may also include a geometry data preprocessor 150 and one or more microprocessor units (MPUs) 152. MPUs 152 may be configured to perform vertex transformation, lighting calculations and other programmable functions, and to send the results to hardware accelerator 18. MPUs 152 may also have read/write access to texels (i.e. the smallest addressable unit of a texture map) and pixels in the hardware accelerator 18. Geometry data preprocessor 150 may be configured to decompress geometry, to convert and format vertex data, to dispatch vertices and instructions to the MPUs 152, and to send vertex and attribute tags or register data to hardware accelerator 18.

As shown, media processor 14 may have other possible interfaces, including an interface to one or more memories. For example, as shown, media processor 14 may include direct Rambus interface 156 to a direct Rambus DRAM (DRDRAM) 16. A memory such as DRDRAM 16 may be used for program and/or data storage for MPUs 152. DRDRAM 16 may also be used to store display lists and/or vertex texture maps.

Media processor 14 may also include interfaces to other functional components of graphics system 112. For example, media processor 14 may have an interface to another specialized processor such as hardware accelerator 18. In the illustrated embodiment, controller 160 includes an accelerated port path that allows media processor 14 to control hardware accelerator 18. Media processor 14 may also include a direct interface such as bus interface unit (BIU) 154. Bus interface unit 154 provides a path to memory 16 and a path to hardware accelerator 18 and video output processor 24 via controller 160.

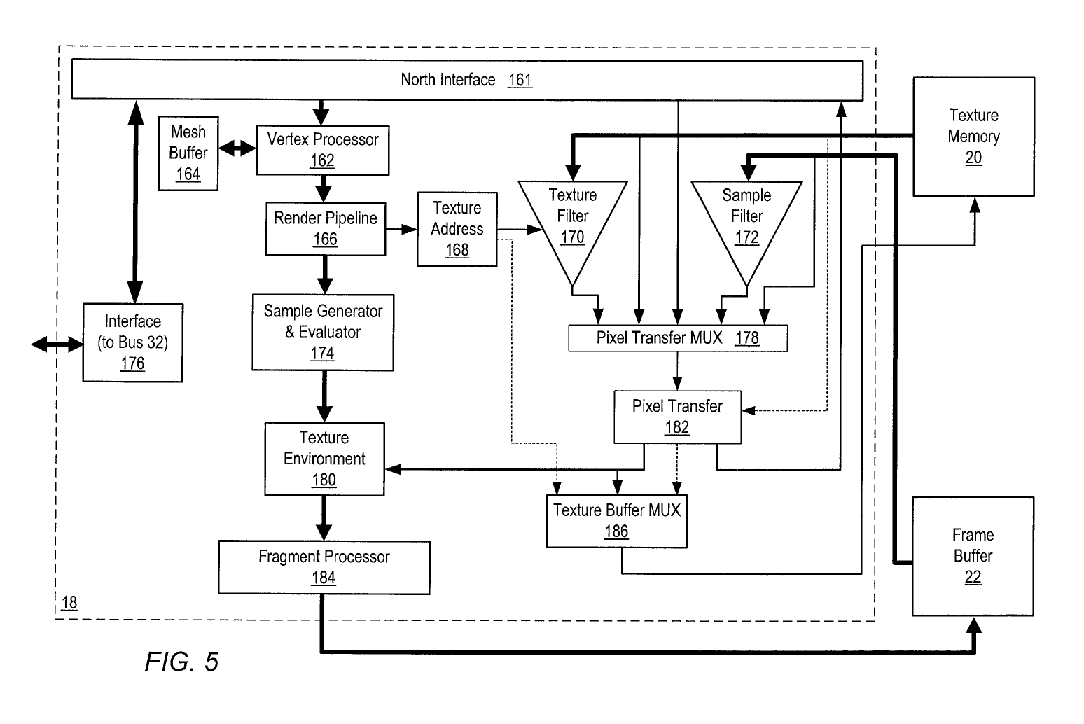

Hardware Accelerator—FIG. 5

One or more hardware accelerators 18 may be configured to receive graphics instructions and data from media processor 14 and to perform a number of functions on the received data according to the received instructions. For example, hardware accelerator 18 may be configured to perform rasterization, 2D and/or 3D texturing, pixel transfers, imaging, fragment processing, clipping, depth cueing, transparency processing, set-up, and/or screen space rendering of various graphics primitives occurring within the graphics data.

Clipping refers to the elimination of graphics primitives or portions of graphics primitives that lie outside of a 3D view volume in world space. The 3D view volume may represent that portion of world space that is visible to a virtual observer (or virtual camera) situated in world space. For example, the view volume may be a solid truncated pyramid generated by a 2D view window, a viewpoint located in world space, a front clipping plane and a back clipping plane. The viewpoint may represent the world space location of the virtual observer. In most cases, primitives or portions of primitives that lie outside the 3D view volume are not currently visible and may be eliminated from further processing. Primitives or portions of primitives that lie inside the 3D view volume are candidates for projection onto the 2D view window.

Set-up refers to mapping primitives to a three-dimensional viewport. This involves translating and transforming the objects from their original “world-coordinate” system to the established viewport's coordinates. This creates the correct perspective for three-dimensional objects displayed on the screen.

Screen-space rendering refers to the calculations performed to generate the data used to form each pixel that will be displayed. For example, hardware accelerator 18 may calculate “samples.” Samples are points that have color information but no real area. Samples allow hardware accelerator 18 to “super-sample,” or calculate more than one sample per pixel. Super-sampling may result in a higher quality image.

Hardware accelerator 18 may also include several interfaces. For example, in the illustrated embodiment, hardware accelerator 18 has four interfaces. Hardware accelerator 18 has an interface 161 (referred to as the “North Interface”) to communicate with media processor 14. Hardware accelerator 18 may receive commands and/or data from media processor 14 through interface 161. Additionally, hardware accelerator 18 may include an interface 176 to bus 32. Bus 32 may connect hardware accelerator 18 to boot PROM 30 and/or video output processor 24. Boot PROM 30 may be configured to store system initialization data and/or control code for frame buffer 22. Hardware accelerator 18 may also include an interface to a texture buffer 20. For example, hardware accelerator 18 may interface to texture buffer 20 using an eight-way interleaved texel bus that allows hardware accelerator 18 to read from and write to texture buffer 20. Hardware accelerator 18 may also interface to a frame buffer 22. For example, hardware accelerator 18 may be configured to read from and/or write to frame buffer 22 using a four-way interleaved pixel bus.

The vertex processor 162 may be configured to use the vertex tags received from the media processor 14 to perform ordered assembly of the vertex data from the MPUs 152. Vertices may be saved in and/or retrieved from a mesh buffer 164.

The render pipeline 166 may be configured to rasterize 2D window system primitives and 3D primitives into fragments. A fragment may contain one or more samples. Each sample may contain a vector of color data and perhaps other data such as alpha and control tags. 2D primitives include objects such as dots, fonts, Bresenham lines and 2D polygons. 3D primitives include objects such as smooth and large dots, smooth and wide DDA (Digital Differential Analyzer) lines and 3D polygons (e.g. 3D triangles).

For example, the render pipeline 166 may be configured to receive vertices defining a triangle, to identify fragments that intersect the triangle.

The render pipeline 166 may be configured to handle full-screen size primitives, to calculate plane and edge slopes, and to interpolate data (such as color) down to tile resolution (or fragment resolution) using interpolants or components such as:

r, g, b (i.e., red, green, and blue vertex color);

r2, g2, b2 (i.e., red, green, and blue specular color from lit textures);

alpha (i.e. transparency);

z (i.e. depth); and

s, t, r, and w (i.e. texture components).

In embodiments using super-sampling, the sample generator 174 may be configured to generate samples from the fragments output by the render pipeline 166 and to determine which samples are inside the rasterization edge. Sample positions may be defined by user-loadable tables to enable stochastic sample-positioning patterns.

Hardware accelerator 18 may be configured to write textured fragments from 3D primitives to frame buffer 22. The render pipeline 166 may send pixel tiles defining r, s, t and w to the texture address unit 168. The texture address unit 168 may use the r, s, t and w texture coordinates to compute texel addresses (e.g. addresses for a set of neighboring texels) and to determine interpolation coefficients for the texture filter 170. The texel addresses are used to access texture data (i.e. texels) from texture buffer 20. The texture buffer 20 may be interleaved to obtain as many neighboring texels as possible in each clock. The texture filter 170 may perform bilinear, trilinear or quadlinear interpolation. The pixel transfer unit 182 may also scale and bias and/or lookup texels. The texture environment 180 may apply texels to samples produced by the sample generator 174. The texture environment 180 may also be used to perform geometric transformations on images (e.g., bilinear scale, rotate, flip) as well as to perform other image filtering operations on texture buffer image data (e.g., bicubic scale and convolutions).

Note that texture buffer 20 is so named because in many applications, it may be used to store texture information. However, more generally, texture buffer 20 may be used as a buffer to store any desired kind of information. In one set of applications, a portion of texture buffer 20 may be used to as an accumulation buffer for mixing a sequence of images.

In the illustrated embodiment, the pixel transfer MUX 178 controls the input to the pixel transfer unit 182. The pixel transfer unit 182 may selectively unpack pixel data received via north interface 161, select channels from either the frame buffer 22 or the texture buffer 20, or select data received from the texture filter 170 or sample filter 172.

The pixel transfer unit 182 may be used to perform scale, bias, and/or color matrix operations, color lookup operations, histogram operations, accumulation operations, normalization operations, and/or min/max functions. Depending on the source of (and operations performed on) the processed data, the pixel transfer unit 182 may output the processed data to the texture buffer 20 (via the texture buffer MUX 186), the frame buffer 22 (via the texture environment unit 180 and the fragment processor 184), or to the host (via north interface 161). For example, in one embodiment, when the pixel transfer unit 182 receives pixel data from the host via the pixel transfer MUX 178, the pixel transfer unit 182 may be used to perform a scale and bias or color matrix operation, followed by a color lookup or histogram operation, followed by a min/max function. The pixel transfer unit 182 may then output data to either the texture buffer 20 or the frame buffer 22.

Fragment processor 184 may be used to perform standard fragment processing operations such as the OpenGL® fragment processing operations. For example, the fragment processor 184 may be configured to perform the following operations: fog, area pattern, scissor, alpha/color test, ownership test (WID), stencil test, depth test, alpha blends or logic ops (ROP), plane masking, buffer selection, pick hit/occlusion detection, and/or auxiliary clipping in order to accelerate overlapping windows.

Texture Buffer 20

Texture buffer 20 may include several SDRAMs. Texture buffer 20 may be configured to store texture maps, image processing buffers, and accumulation buffers for hardware accelerator 18. Texture buffer 20 may have many different capacities (e.g., depending on the type of SDRAM included in texture buffer 20). In some embodiments, each pair of SDRAMs may be independently row and column addressable.

Frame Buffer 22

Graphics system 112 may also include a frame buffer 22. In one embodiment, frame buffer 22 may include multiple memory devices such as 3D-RAM memory devices manufactured by Mitsubishi Electric Corporation. Frame buffer 22 may be configured as a display pixel buffer, an offscreen pixel buffer, and/or a super-sample buffer. Furthermore, in one embodiment, certain portions of frame buffer 22 may be used as a display pixel buffer, while other portions may be used as an offscreen pixel buffer and sample buffer.

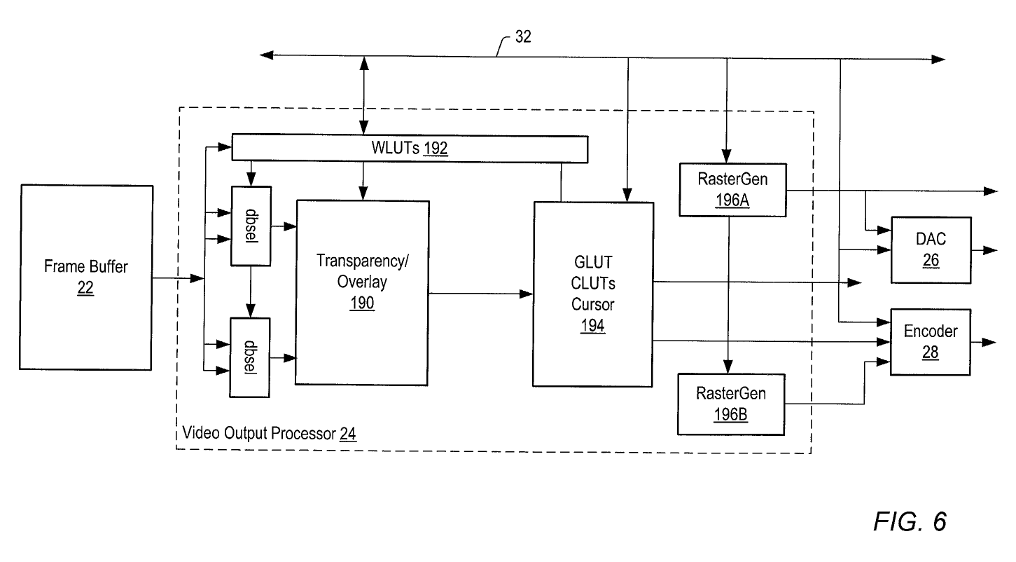

Video Output Processor—FIG. 6

A video output processor 24 may also be included within graphics system 112. Video output processor 24 may buffer and process pixels output from frame buffer 22. For example, video output processor 24 may be configured to read bursts of pixels from frame buffer 22. Video output processor 24 may also be configured to perform double buffer selection (dbsel) if the frame buffer 22 is double-buffered, overlay transparency (using transparency/overlay unit 190), plane group extraction, gamma correction, psuedocolor or color lookup or bypass, and/or cursor generation. For example, in the illustrated embodiment, the output processor 24 includes WID (Window ID) lookup tables (WLUTs) 192 and gamma and color map lookup tables (GLUTs, CLUTs) 194. In one embodiment, frame buffer 22 may include multiple 3DRAM64s 201 that include the transparency overlay 190 and all or some of the WLUTs 192. Video output processor 24 may also be configured to support two video output streams to two displays using the two independent video raster timing generators 196. For example, one raster (e.g., 196A) may drive a 1280×10²⁴ CRT while the other (e.g., 196B) may drive a NTSC or PAL device with encoded television video.

DAC 26 may operate as the final output stage of graphics system 112. The DAC 26 translates the digital pixel data received from GLUT/CLUTs/Cursor unit 194 into analog video signals that are then sent to a display device. In one embodiment, DAC 26 may be bypassed or omitted completely in order to output digital pixel data in lieu of analog video signals. This may be useful when a display device is based on a digital technology (e.g., an LCD-type display or a digital micro-mirror display).

DAC 26 may be a red-green-blue digital-to-analog converter configured to provide an analog video output to a display device such as a cathode ray tube (CRT) monitor. In one embodiment, DAC 26 may be configured to provide a high resolution RGB analog video output at dot rates of 240 MHz. Similarly, encoder 28 may be configured to supply an encoded video signal to a display. For example, encoder 28 may provide encoded NTSC or PAL video to an S-Video or composite video television monitor or recording device.

In other embodiments, the video output processor 24 may output pixel data to other combinations of displays. For example, by outputting pixel data to two DACs 26 (instead of one DAC 26 and one encoder 28), video output processor 24 may drive two CRTs. Alternately, by using two encoders 28, video output processor 24 may supply appropriate video input to two television monitors. Generally, many different combinations of display devices may be supported by supplying the proper output device and/or converter for that display device.

Sample-to-Pixel Processing Flow

In one set of embodiments, hardware accelerator 18 may receive geometric parameters defining primitives such as triangles from media processor 14, and render the primitives in terms of samples. The samples may be stored in a sample storage area (also referred to as the sample buffer) of frame buffer 22. The samples are then read from the sample storage area of frame buffer 22 and filtered by sample filter 22 to generate pixels. The pixels are stored in a pixel storage area of frame buffer 22. The pixel storage area may be double-buffered. Video output processor 24 reads the pixels from the pixel storage area of frame buffer 22 and generates a video stream from the pixels. The video stream may be provided to one or more display devices (e.g. monitors, projectors, head-mounted displays, and so forth) through DAC 26 and/or video encoder 28.

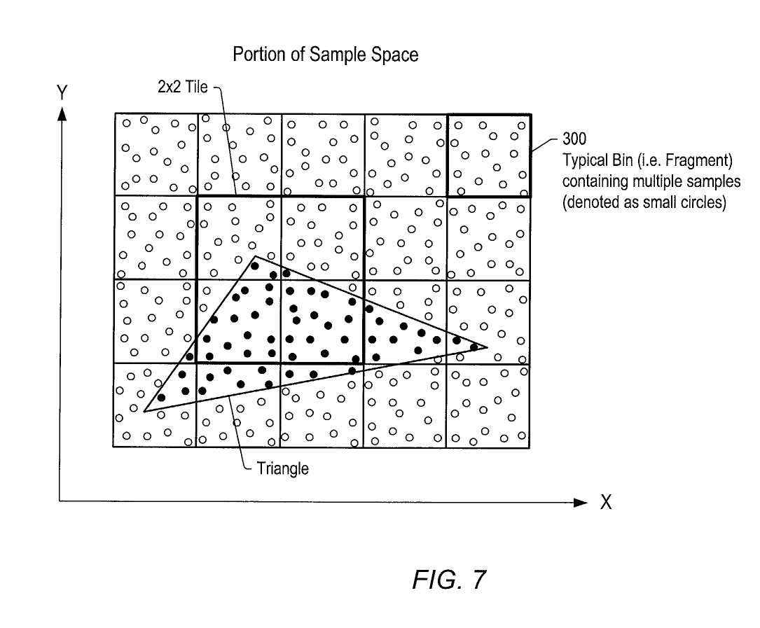

The samples are computed at positions in a two-dimensional sample space (also referred to as rendering space). The sample space may be partitioned into an array of bins (also referred to herein as fragments). The storage of samples in the sample storage area of frame buffer 22 may be organized according to bins as illustrated in FIG. 7. Each bin may contain one or more samples. The number of samples per bin may be a programmable parameter.

Dynamic Image Blending using an Accumulation Buffer

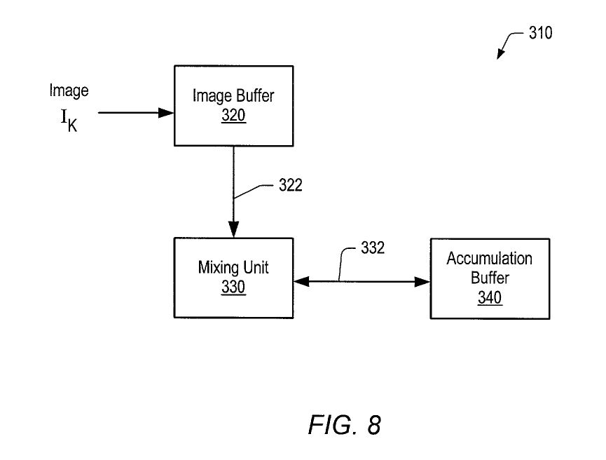

Let X₀, X₁, X₂, X₃, . . . , X_{K}, . . . be a sequence of images. Each image X_{K} may be a rectangular array of pixels. Each image X_{K} of the image sequence may have the same horizontal and vertical resolution. FIG. 8 illustrates one set of embodiments of a system 310 for blending the sequence of images. Blending system 310 may include an image buffer 320, a mixing unit 330 and an accumulation buffer 340. The depth resolution (i.e. number of bits per pixel) of the accumulation buffer 340 may be greater than the depth resolution of the image buffer 320.

Each image X_{K} of the image sequence may be written into image buffer 320 by some external agent. Mixing unit 330 mixes each image X_{K} into a composite image A_{K} which develops in accumulation buffer 340.

Mixing unit 330 performs a dynamic mixing operation on pixels of the image X_{K} stored in image buffer 320 with respect to corresponding pixels in the accumulation buffer 340. The dynamic mixing operation may be described by the recursive expression:

A_{K+1}(I,J)=α_{K}(I,J)*(X_{K}(I,J)−A_{K}(I,J))+A_{K}(I,J) (2)

where

A_{K}(I,J) denotes the (I,J)^{th} pixel of the accumulation buffer prior to mixing with image X_{K};

A_{K+1}(I,J) denotes the (I,J)^{th} pixel of the accumulation buffer after mixing with image X_{K};

X_{K}(I,J) denotes the (I,J)^{th} pixel of the image X_{K};

α_{K}(I,J) denotes the alpha (i.e. transparency) component of the image pixel X_{K}(I,J).

The indices I and J are horizontal and vertical pixel indices. The expression (2) is a vector expression having three components, one for each of red, green and blue. The transparency value α_{K}(I,J) may be the same for all three component expressions. The term “dynamic” is used to describe expression (2) because each pixel position (I,J) has a corresponding mixing factor α_{K}(I,J).

Mixing unit 330 receives a stream of the image pixels X_{K}(I,J) from the image buffer 320 and a stream of the pixels A_{K}(I,J) from the accumulation buffer 340, and generates a stream of the output pixels A_{K+1}(I,J) which are sent back to the accumulation buffer 340. In one set of embodiments, the coupling between the image buffer 320 and mixing unit 330, and/or, the coupling between mixing unit 330 and the accumulation buffer 340 may be indirect couplings with one or more intervening units/devices.

Let N_{S} denote the precision (i.e. the number of bits) of a color component of an image pixel in the image buffer 320. Let N_{A} denote the precision of a color component of an accumulation buffer pixel. In one set of embodiments, the accumulation color precision N_{A} may be set equal to N_{S}+ΔN, where ΔN equals the base two logarithm of the maximum expected number of images to be mixed. For example, if the maximum number of images to be mixed is 256, then N_{A} may exceed N_{S} by eight bits. After all the desired images have been mixed into the accumulation buffer 340, the pixels of the accumulation buffer 340 may be transferred to a video display buffer, and thence, to a display device through a digital-to-analog converter (DAC).

In some embodiments, the color components of pixels in the video display buffer may have a precision N_{V} large enough so that viewers of the display device are not able to perceive adverse effects due to the quantization of color. For example, N_{V} may equal eight, nine or ten.

In one embodiment, the image color precision N_{S} may equal the video output color precision N_{V}. Because the accumulation color precision N_{A} is larger than the video output color precision, there is room in the lower (N_{A}−N_{V}) bits of the pixel components in the accumulation buffer for round-off errors to accumulate without affecting the upper N_{V} bits which will get displayed.

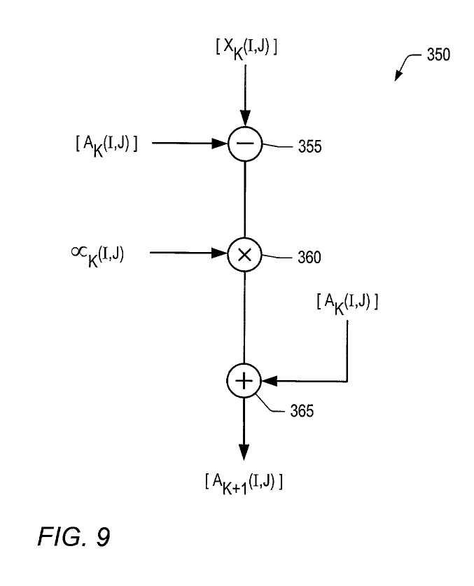

Mixing unit 330 may include a mixing circuit such as the mixing circuit 350 indicated by FIG. 9 to implement the dynamic mixing operation. The mixing circuit 350 may include a subtractor 355, a multiplier 360 and an adder 365 to implement to the calculation indicated by expression (2). The notation [X_{K}(I,J)] denotes one of the color components (i.e. red, green or blue) of the image pixel X_{K}(I,J). The notation [A_{K}(I,J)] denotes the corresponding color component of the accumulation buffer pixel A_{K}(I,J). Mixing unit 330 may include multiple copies of mixing circuit 350 in order to process multiple color components (for one or more pixels) in parallel. Mixing unit 330 may incorporated in a graphics rendering chip.

In one set of embodiments, mixing unit 330 may reside within hardware accelerator 18. For example, mixing unit 330 may reside within the pixel transfer unit 182 of hardware accelerator 18.

In some embodiments, image buffer 320 may be an allocated portion of frame buffer 22, and the accumulation buffer 340 may be an allocated portion of the texture buffer 20.

Software running on the host processor 102 may configure the hardware accelerator 18 to store (or, render and store) the image X_{K} into the frame buffer 22 (i.e. the image buffer 320 allocated within frame buffer 22), and then reconfigure the hardware accelerator 18 to perform the dynamic mixing operation described above. In one embodiment of the dynamic mixing operation:

(a) image pixels X_{K}(I,J) of image X_{K} are transferred from frame buffer 22 through pixel transfer MUX 178 to pixel transfer unit 182;

(b) accumulation buffer pixels A_{K}(I,J) are transferred from the texture buffer 20 through the pixel transfer MUX 178 to the pixel transfer unit 182;

(c) pixel transfer unit 182 performs the computation described by expression (2) on its input streams X_{K}(I,J) and A_{K}(I,J) to generate an output pixel stream A_{K+1}(I,J); and

(d) the output pixel stream A_{K+1}(I,J) is transferred from the pixel transfer unit 182 back to texture buffer 20 (e.g., through texture buffer MUX 186).

In some embodiments, hardware accelerator 18 may couple to texture buffer 20 through a single bus. Thus, processes (b) and (d) may share the single bus. In this case, pixels may be read from and written to the texture buffer 20 in bursts (i.e. groups of pixels/texels) to increase transfer efficiency. Hardware accelerator 18 may couple to texture buffer 20 and frame buffer 22 through separate busses. Thus, process (a) may operate in parallel with processes (b) and (d).

Reconfigurable Pixel Computation Unit

In one set of embodiments, a pixel computation unit (e.g. pixel transfer unit 182) may include a scale and bias unit, and a pixel map with a plurality of lookup tables. The input data supplied to the pixel transfer unit 182 may come from any of the following sources: north interface 161, frame buffer 22, texture buffer 20, or the output of texture filter 170. The texture buffer 20 may stored texture or image data, or accumululation buffer data. (A portion of the texture buffer 20 may be allocated as an accumulation buffer).

The output data generated by the pixel transfer unit 182 may be sent to the host interface 11, frame buffer 22, texture buffer 20, or the accumulation buffer (within texture buffer 20). The pixel transfer unit 182 may be used to perform the following operations.

Scale and bias of input pixels.

GL_ACCUM by multiplying each input pixel color/α from the frame buffer 22 with a given value, and adding the result to the accumulation buffer.

GL_ADD and GL_MULT by adding or multiplying the value of each pixel of the accumulation buffer by a given value, and then returning it to the accumulation buffer;

Dynamic mixing as indicated by expression (2). This may be used for α compositing of 3D texture slices. A pixel in the frame buffer is blended with a pixel in the accumulation buffer, using the frame buffer α as the blending coefficient, and the result is stored in the accumulation buffer.

GL_RETURN by taking a pixel from the accumulation buffer, multiplying it with a given value, and storing the results in the frame buffer.

GL_LOAD by taking an input pixel from the frame buffer, multiplying it by a given value, and storing the results in the accumulation buffer.

Color matrix transformations.

A lookup table (LUT) operation, or a histogram operation, using the LUTs.

The pixel transfer unit 182 may be configured in multiple different ways to provide the functionality required by an application. Some applications may call for multiple passes through the hardware accelerator 18 and/or media processor 14.

Pixel/texel data passing through the pixel transfer unit 182 may have a variety of sources and/or destinations, each having a particular alignment and packing within pixel blocks.

The pixel transfer MUX 178 may handle the unpacking and unformatting of input data for the pixel transfer unit 182. The pixel transfer unit 182 may include an output formatter that handles the reformatting and packing of data to be sent out of the pixel transfer unit 182.

The pixel transfer unit 182 may include a scale and bias unit (SBU). The SBU may be used to, e.g.,

scale and bias an input pixel;

scale an input pixel, and add the results to the accumulation buffer;

blend an input pixel (from the frame buffer) into the accumulation buffer, using the α component of the input pixel as the blend coefficient;

perform color space conversion on the input pixel, using a color matrix, which may be, e.g.,

4×4 for transforming RGBα pixels;

3×3 for transforming to RGB, pixels which may have any of the input formats RGB, YCrCb or 422 YCrCb.

The SBU may include a multiplier and adder for performing the scale and bias operations. The SBU may also include an accumulator register for accumulating the sum of products called for by the color matrix operations through multiple cycles. The pixel transfer unit 182 may include multiple copies of the SBU. For example, the pixel transfer unit 182 may have four copies of the SBU. In some modes, each copy may operate on a corresponding one of the four channels R,G,B,α.

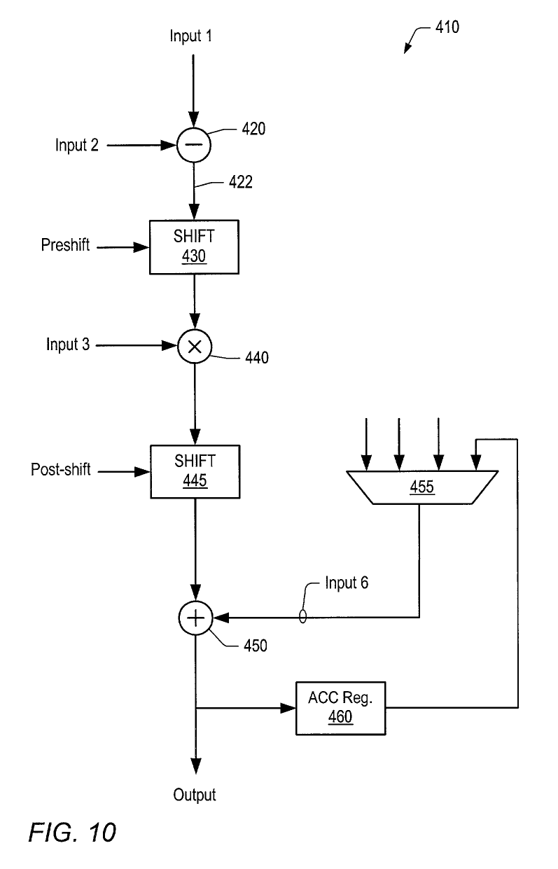

In one set of embodiments, the SBU may have a structure as indicated in FIG. 10. The SBU 410 may include a subtraction unit 420, a shift unit 430, a multiplier 440, a shift unit 445, an adder 450, a multiplexor 455, and an accumulation register 460 (not to be confused with the accumulation buffer 340). The SBU 410 operates on one or more stream of input pixels and generates a stream of output pixels. The SBU 410 generates each pixel of the output stream according to any one of a set of programmably determined operations as follows. To implement a dynamic mixing operation, a color component of an image pixel X_{K}(I,J) from the image buffer in frame buffer 22 may be provided to Input1, and the corresponding color component of accumulation buffer pixel A_{K}(I,J) may be provided to Input2 and to Input6 (through multiplexor 455). The α component of the image pixel X_{K}(I,J) may be provided to Input3. The ouput value OUTPUT may be sent back to the accumulation buffer.

The shift units 430 and 445 allow the SBU 410 to shift the outputs of subtractor 420 and multiplier 440 respectively. In one embodiment, the shift units may be left shift units. Shift unit 430 may be controlled by a preshift value and the shift unit 445 may be controlled by a post-shift value. The preshift and postshift values may be determined by driver software (e.g. software executing on host processor 102). Driver software may write to a preshift register and postshift register in the pixel transfer unit 182. For example, in one set of embodiments, shift unit 420 may be used to remove leading zeros from an operand provide on pathway 422.

To implement a load operation (e.g. a GL_LOAD operation), a component of an image pixel from the image buffer in the frame buffer 22 is provided to Input1. The value zero may be provided to Input2. A programmable scale factor may be provided to Input3. Input6 may be set to zero (e.g. a zero input to multiplexor 455 is selected to pass through to the multiplexor output). The output value OUTPUT is transferred to the accumulation buffer.

To implement a return operation (e.g. a GL RETURN operation), a component CC_{A} of an accumulation buffer pixel is provided to pathway 422, a programmable scale factor is provided to Input3, and Input6 is set to zero (e.g. a zero input to multiplexor 455 is selected to pass through to the multiplexor output). The pathway 422 may be provided with the component CC_{A} in any of various ways. For example, CC_{A} may be provided to Input1 and zero may be provided to Input2. The output value OUTPUT is transferred to the frame buffer 22 (e.g. to the image buffer in frame buffer 22).

To implement an add operation (e.g. a GL_ADD operation), a component CC_{A} of an accumulation buffer pixel is provided to pathway 422, the value one is provided at Input3 for the scale factor, and a programmable bias value is provided at Input6 (e.g. a selecting an input line of multiplexor 455 which couples to a bias value register). The output value OUTPUT is sent to the accumulation buffer (in texture buffer 20).

The pathway 422 may be provided with the component CC_{A} in any of various ways. For example, in one alternative embodiment, subtraction unit 420 (which includes an internal adder and a two's complement unit) may have an alternative path around its two's complement unit, i.e. an alternative path that goes from Input2 to an input port of the internal adder. When the bypass path is enabled, Input2 goes directly to the internal adder port. Thus, the component CC_{A} may be provided to path 422 by providing the component CC_{A} to Input2, zero to Input1, and enabling the alternative path.

To implement a multiply operation (e.g. a GL_MULT operation), a component CC_{A} of an accumulation buffer pixel is provided to pathway 422, a programmably-determined value is provided at Input3 for the scale factor, and the value zero is provided at Input6 (e.g. a zero input to multiplexor 455 is selected to pass through to the multiplexor output). The output value OUTPUT is sent to the accumulation buffer (in texture buffer 20).

To implement an accumulate operation (e.g. a GL_ACCUM operation), a component of an image pixel from the image buffer in the frame buffer 22 is provided to Input1. The value zero may be provided to Input2. A programmable scale factor may be provided to Input3. The corresponding component of accumulation buffer pixel A_{K}(I,J) may be provided to Input6 (via multiplexor 455). The output value OUTPUT is transferred to the accumulation buffer.

In one embodiment, the pixel transfer unit 182 may include four copies of the SBU 410. Thus, the pixel transfer unit 182 may operate on four input channels simultaneously. For example, the four input channels may be allocated respectively to the four pixel components (red, green, blue and alpha). Thus, in at least some operational modes (e.g., in the load, return, add, multiply and accumulate modes), the pixel transfer unit 182 may compute all four components for a single pixel in parallel.

Furthermore, the pixel transfer unit 182 may be configured to operate on more than one pixel simultaneously. For example, two pixels may be processed per clock under the assumption that each pixel uses two channels. Or, four pixels may be processed per clock under the assumption that each pixel uses one channel.

In the dynamic mixing operation, the alpha component of the image pixel is used to determine the blend factor for the red, green and blue components, and thus, the alpha component may not experience the same kind of mixing as the red, green and blue components.

To implement a matrix-vector multiplication Z=C*U, e.g., a color space conversion, each component Z_{L} of the output vector is assigned to a correspoding copy of the SBU 410. Each copy of the SBU 410 receives the components U_{M} of the input vector over successive clock cycles, and multiplies each component U_{M} by the matrix coefficient C_{LM}. A sum of the products C_{LM}*U_{M} is accumulated in accumulator register 460. The input vector components may be presented successively at Input1. Input2 may be set to zero. The matrix coefficients C_{LM} may be multiplexed into Input3 over the successive cycles. The output of accumulator register 460 may be fed back through multiplexor 455 to adder 450 through Input6.

Three copies of the SBU 410 may be used in parallel to perform a 3×3 matrix multiply. Four copies of the SBU 410 may be used in parallel to perform a 4×4 matrix multiply.

The matrix multiplication modes may be used to perform any of the following color space conversions:

YUV to RGB;

422YUV to RGB (each 422YUV input pixel may produce two RGB pixels of output);

RGB to RGB;

RGBα to RGBα

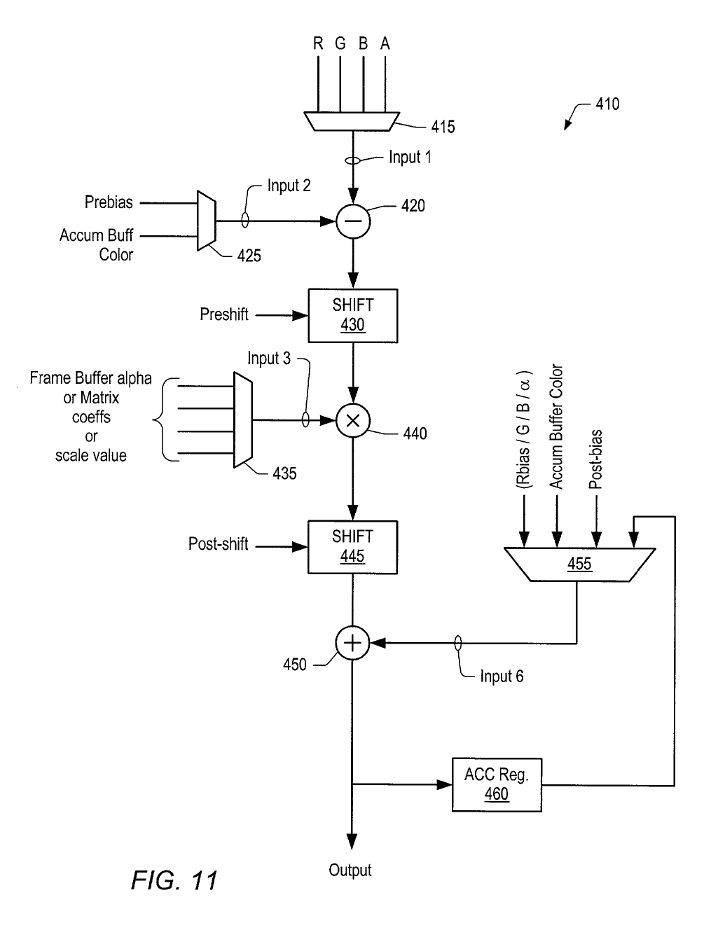

SBU 410 includes a set of multiplexors so that appropriate values as supplied to each of the inputs Input1, Input2, Input3 and Input6 for each operational mode. For example, in one embodiment, SBU 410 may include multiplexors 415, 425, 435 and 455 as indicated in FIG. 11.

The multiplexor 425 may select between a pre-bias value and accumulation buffer pixel color.

The multiplexor 435 may select between matrix coefficients in matrix multiply mode. In dynamic blending mode, multiplexor 435 passes the frame buffer α value. In multiply mode, multiplexor 435 passes the registered scale value (i.e. programmably determined scale value).

Multiplexor 455 provides one of a color bias constant, the accumulation buffer pixel color, a post-bias constant, or accumultor register contents to Input6. The color bias constant may be useful in certain color space conversions. The post-bias constant may be used in the add operation. The accumulation buffer pixel color may be selected during the dynamic mixing operation.

Pixel transfer unit 182 may also include a control unit (not shown). The control unit drives the control lines (i.e. the select lines) of the multiplexors through one or more cycles to implement the various operations described above. The control unit responds to a value stored in an operation register. The operation register may be programmably determined (e.g. a host software).

In one set of embodiments, the inputs to the pixel transfer unit 182 may be four channels of pixel data (i.e. one 4-channel pixel, two 2-channel pixels, or four 1-channel pixels). The pixel transfer unit 182 may also receive a three-channel accumulation buffer pixel during the dynamic blending mode.

The pixel transfer unit 182 may include a set of registers that store operational parameters such as scale value, shift values, bias values, matrix coefficients, and so on. For example, 16 scale values may be stored to support 4×4 matrix operation. The control unit is responsible for cycling through the different channels of input data and selecting the correct combination of inputs and register values to perform the desired operation.

In other embodiments, pixel transfer unit 182 may include more than or less than four copies of SBU 140.

Pixel transfer unit 182 has been described mostly in terms of the graphics system embodiment of FIG. 3, and the hardware accelerator embodiment of FIG. 5. However, it is noted that the principles described herein for making and using a reconfigurable pixel computation unit with one or more basic blocks such as SBU 410 may be applied in any of a variety of graphics or video processing systems, or graphics rendering chips.

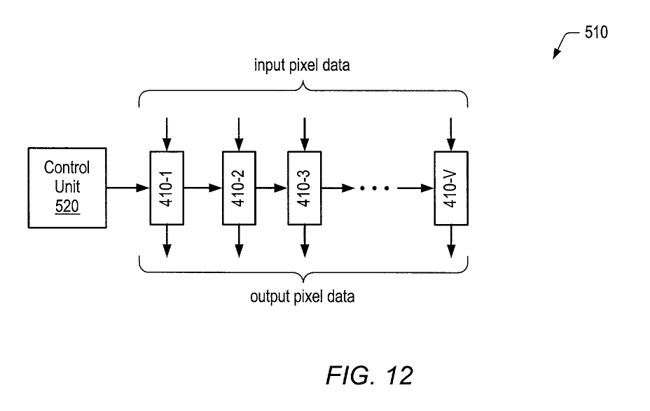

FIG. 12 illustrates one set of embodiments of a reconfigurable computational system 510. System 510 includes a control unit 520, and reconfigurable blocks (or cirucits) 410-1 through 410-V, where V is a positive integer. Each of the reconfigurable blocks may be similar to or identical to SBU 410. Control unit 520 asserts signals which control the select lines of the multiplexors in the reconfigurable blocks 410-1 through 410-V.

The terms “mix” and “blend” as used herein are synonyms.

Although the embodiments above have been described in considerable detail, other versions are possible. Numerous variations and modifications will become apparent to those skilled in the art once the above disclosure is fully appreciated. It is intended that the following claims be interpreted to embrace all such variations and modifications. Note the section headings used herein are for organizational purposes only and are not meant to limit the description provided herein or the claims attached hereto.

What is claimed is:

1. A circuit comprising:
a subtractor coupled to receive a first input and a second input;
a multiplier coupled to a third input and an output of the subtractor;
an adder coupled to a fourth input and an output of the multiplier;
a first multiplexor whose output drives the first input;
a second multipexor whose output drives the second input;
a third multiplexor whose output drives the third input; and
a fourth multiplexor whose output drives the fourth input.

2. The circuit of claim 1 further comprising control logic configured to drive selection lines of the first, second, third and fourth multiplexors in response to a value in an operation register.

3. The circuit of claim 1, wherein, in response to a dynamic blending instruction in the operation register, the control logic is configured to drive the selection lines so that (a) the first multiplexor passes a color value of an image pixel to the first input, (b) the second multiplexor passes a color value of an accumulation buffer pixel to the second input, (c) the third multiplexor passes an alpha component of the image pixel to the third input, (d) the fourth multiplexor passes the color value of the accumulation buffer pixel to the fourth input.

4. The circuit of claim 1, wherein, in response to an add instruction in the operation register, the control logic is configured to drive the selection lines so that (a) the first multiplexor passes a component of an accumulation buffer pixel to the first input, (b) the second multiplexor passes a zero value to the second input, (c) the third multiplexor passes the value one to the third input, (d) the fourth multiplexor passes a bias value to the fourth input.

5. The circuit of claim 1, wherein, in response to an accumulate instruction in the operation register, the control logic is configured to drive the selection lines so that (a) the first multiplexor passes a component of an image pixel to the first input, (b) the second multiplexor passes a zero value to the second input, (c) the third multiplexor passes a scale value to the third input, (d) the fourth multiplexor passes a corresponding component of an accumulation buffer pixel to the fourth input.

6. The circuit of claim 1 further comprising an accumulator register, wherein an input line to the accumulator register couples to the output of the adder, wherein an output line of the accumulator register couples to an input of the fourth multiplexor.

7. The circuit of claim 1 wherein, in response to a matrix-oriented operation in the operation register, the control logic is configured to drive the selection lines so that (a) the first multiplexor passes the successive components of an input vector to the first input in successive cycles, (b) the second multiplexor passes the value zero to the second input in the successive cycles, (c) the third multiplexor passes corresponding matrix coefficients to the third input in the successive cycles, (d) the fourth multiplexor feeds back the output of the accumulator register to the fourth input in at least a subset of the successive cycles.

8. A system comprising:
a frame buffer containing an image buffer;
a texture buffer containing an accumulation buffer;
a pixel transfer unit comprising a control unit and one or more instances of a circuit, wherein the circuit comprises a subtractor, a multiplier, an adder, and a set of multiplexors, wherein the control logic drives select lines of the set of multiplexors in the one or more circuit instances through one or more computational cycles in order to implement a programmable operation, wherein the pixel transfer unit is configured to receive pixels values from one or more sources selected from a set of sources including the frame buffer and the texture buffer, wherein the pixel transfer unit is further configured to implement the programmable operation on the pixel values using said one or more circuit instances to generate a stream of output pixels.

9. The system of claim 8, wherein the color depth precision of the accumulation buffer is larger than the color depth precision of the image buffer.

10. The system of claim 8 further comprising one or more circuit elements configured to transfer the stream of output pixels to a programmable destination.

11. The system of claim 10, wherein the programmable destination is the accumulation buffer.

12. The system of claim 10, wherein the programmable destination is the image buffer.

13. The system of claim 8, wherein the programmable operation includes one or more of an addition operation, a multiply operation, an accumulate operation, a dynamic blending operation, a matrix-vector multiplication, a load operation and a return operation.

14. The system of claim 13, wherein one or more of the circuit instances further includes an accumulator register for accumulating sums over multiple of said computational cycles.
